(19) United States
(12) Patent Application Publication
(10) Pub. No.: US 2009/0206629 A1
(43) Pub. Date: Aug. 20, 2009

(54) MODULAR LIFTERS FOR TARPAULINS

(75) Inventor: Everest DAMSI, Burlington (CA)

Correspondence Address: LANG MICHENER, BCE PLACE, P.O. BOX 747, SUITE 2500, 181 BAY STREET, TORONTO, ON, M5J 2T7, CA

(73) Assignee: ROLL-TITE INC., Norwich, ON (CA)

(21) Appl. No.: 12/369,856

(22) Filed: Feb. 12, 2009

(30) Foreign Application Priority Data
Feb. 15, 2008 (CA) 2621815

(51) Int. Cl. B60P 7/02; B60P 7/04

(52) U.S. Cl. 296/100.14

(57) ABSTRACT

The invention comprises a modular lifter for a tarpaulin system, comprising: a) a plurality of tubes, each end of each tube being a hollow end, and the tubes operative to be assemblable into a lifter for a tarpaulin system; b) a plurality of hinges, each hinge having a body, opposed tube mounting ends extending longitudinally from the body and dimensioned to fit within the hollow ends of the tubes, and locking mount extending from the body substantially perpendicular to the mounting ends; and c) a locking mechanism, operative to couple two of said hinges together via respective locking mounts.

### FIELD OF THE INVENTION

The present invention relates to the field of tarpaulins. In particular, it relates to a modular lifter for use in a tarpaulin system.

### BACKGROUND OF THE INVENTION

Lifters are used as part of a tarpaulin system to reduce the pleat of the tarpaulin during retraction, such that the tarpaulin does not interfere or get caught up in the cargo or the bows during retraction and unloading. The lifters also reduce wear on the tarpaulin caused by sections folding against each other during retraction. Lifters are commonly tubes made from a lightweight material, such as aluminum or steel, which is also capable of maintaining a rigid form, and is usually the same material as the tarpaulin bows.

One problem encountered with litters is that, when the tarpaulin is removed, the lifters are vulnerable to damage from exposure to the elements, or from the cargo loading process. Another problem is that removal and attachment of lifters to a cargo bed can be cumbersome and difficult, given the large size of some lifters and cargo vehicles.

There is a need for a lifter which is modular, to provide for easier and quicker attachments and removal of lifters to a cargo bed. There is also a need for a lifter which minimizes the weight of the corresponding bow.

One attempt at addressing issues with lifters is found in U.S. Pat. No. 6,634,697 to Petelka (“Petelka”). Petelka uses shortened pivoting support braces extending from the individual bows as lifters. The braces have the pivots on the bows abutting the exterior of the tarpaulin area, they remain at risk of damage from external contact, as well as damage from the elements. Additionally, the use of full U-shaped bows as braces increases both the weight of the individual bows, as well as the total tarpaulin system.

Another attempt at created a modular lifter is found in Canadian Application No. 2,515,656 of Petelka (“Petelka application”). The application discloses a sliding tarpaulin system for use in converting a flatbed trailer to a covered trailer. The Petelka application uses a set of tabs joined by an intermediate rod to connect and support the lifters between the bows. The tabs are at risk of becoming bent or otherwise misaligned through use, preventing the intermediate rod from passing through and thus preventing proper connection and operation of the lifters.

It is an object of this invention to partially or completely fulfill one or more of the above-mentioned needs and partially or completely overcome one or more of the limitations of the prior art.

### SUMMARY OF THE INVENTION

According to one aspect of the invention, the invention comprises a modular lifter for a tarpaulin system, comprising: a) a plurality of tubes, each end of each tube being a hollow end, and the tubes operative to be assemblable into a lifter for a tarpaulin system; b) a plurality of hinges, each hinge having a body, opposed tube mounting ends extending longitudinally from the body and dimensioned to fit within the hollow ends of the tubes, and locking mount extending from the body substantially perpendicular to the mounting ends; and c) a locking mechanism, operative to couple two of said hinges together via respective locking mounts.

Optionally, the locking mechanism is a clevis pin and the locking mount contains an aperture for passage of the clevis pin. Additionally, the clevis pin can use a reusable cotter pin. An alternative locking mechanism is a nut and bolt.

Optionally, the body, the tube mounting ends and the locking mount of the hinge are a single body.

According to another aspect of the invention, the invention further comprises a hinge for a tarpaulin system, comprising: a) a body, b) a pair of tube mounting ends, each tube mounting end extending laterally from opposite ends of the main body, and c) a locking mount extending perpendicular to the main body and enabling the hinge to be coupled to a second hinge of similar design.

Optionally, the locking mount contains an aperture to enable coupling of the second hinge via a clevis pin. Additionally, the clevis pin can use a reusable cotter pin. An alternative locking mount uses a nut and bolt in lieu of a clevis pin.

Optionally, the body, the tube mounting ends and the locking mount of the hinge are a single body

Other and further advantages and features of the invention will be apparent to those skilled in the art from the following detailed description thereof, taken in conjunction with the accompanying drawings.

### BRIEF DESCRIPTION OF THE DRAWINGS

The invention will now be described in more detail, by way of example only, with reference to the accompanying drawings, in which like numbers refer to like elements, wherein:

FIG. 1A is an exploded view of a single lifter according to an embodiment of the present invention;

FIG. 1B is a perspective view of a modular lifter according to an embodiment of the present invention;

FIG. 2 is a perspective view of a hinge according to an embodiment of the present invention;

FIG. 3A is an exploded perspective view of a pair of hinges and attached tubes

FIG. 3B is a perspective view of the assembled hinges of FIG. 3A;

FIG. 4 is a perspective view of an assembled tarpaulin system in a closed position using the lifters of FIG. 1B; and

FIG. 5 is a perspective view of the assembled tarpaulin system of FIG. 4 in an open position.

### DETAILED DESCRIPTION OF THE PREFERRED EMBODIMENTS

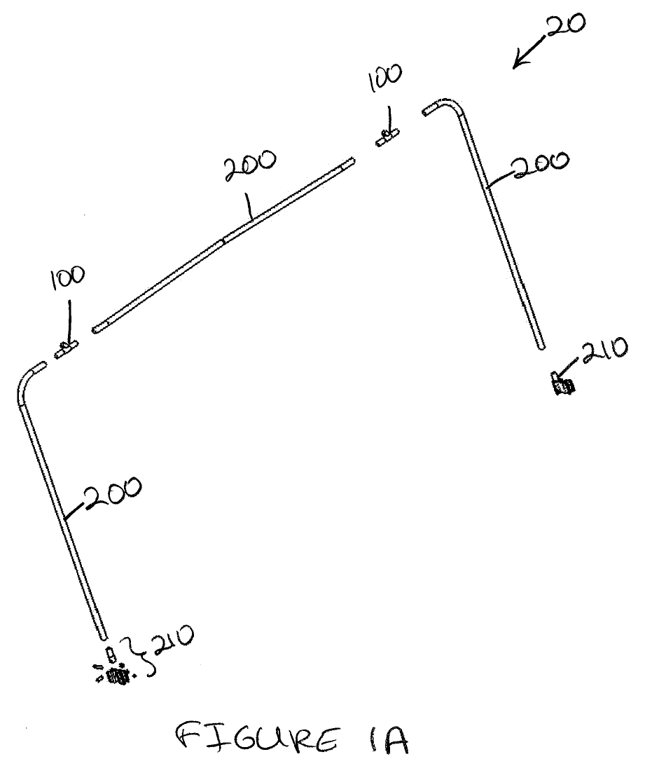

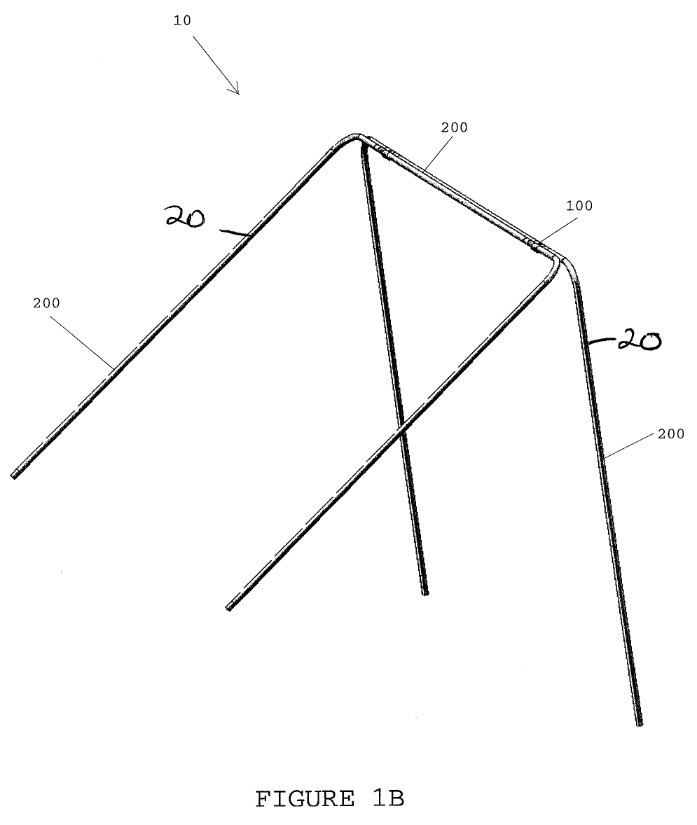

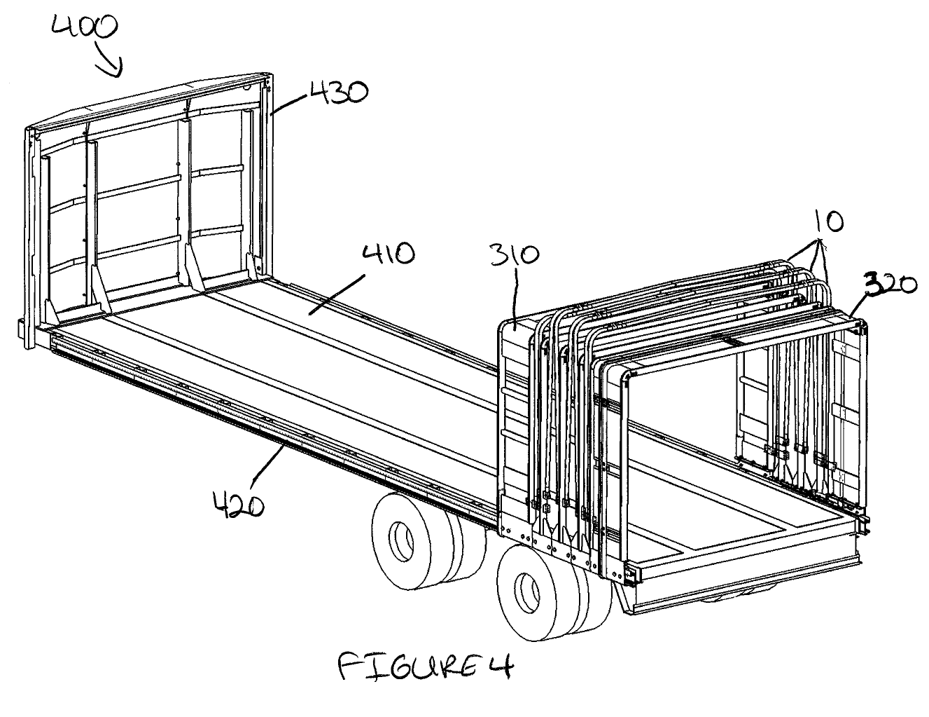

The invention presented herein comprises a modular lifter for a tarpaulin system which is based oil a lifter frame 20 assembled from a group of lightweight tubes 200 connected by a series of hinges 100 as shown in FIG. 1A. As shown in FIG. 1B, the lifter 10 is assembled from a pair of lifter frames 20 which are pivotally connected through hinges 100. The lifters 10 are secured to the tarpaulin system by pivoting mounts 210 which secure the lifters 10 to the bows 300 (as shown in FIG. 4).

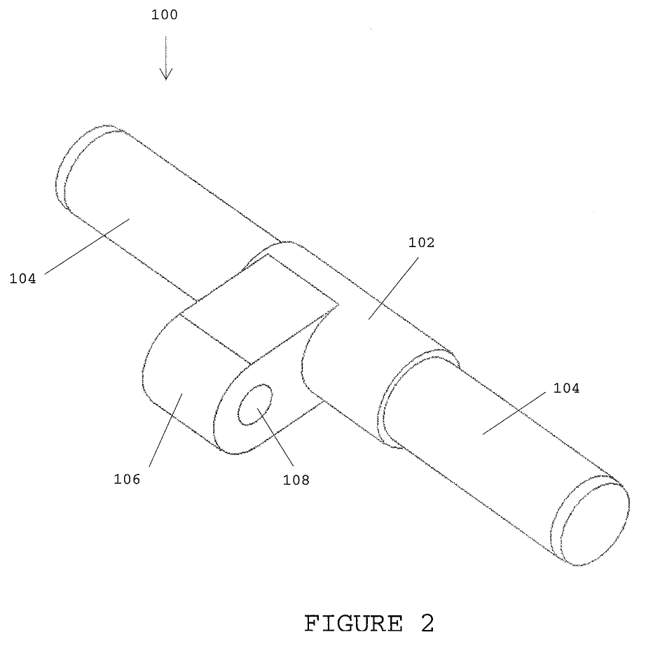

As best shown in FIG. 2, the hinge 100 has a main body 102, a pair of tube mounting ends 104 extending parallel from the main body 102, and a locking mount 106 extending perpendicular to main body 102, with a aperture or channel 108 within running parallel to main body 102. As part of the overall system, a clevis pin 110, with a washer 112 and cotter pin 114 (shown as a ring-type cotter pin) are included for use in coupling together two hinges 100 via aperture 108 in locking mount 106 as described below. Due to its design for speed and ease of engagement, and potential for reusability via cotter pin 114, clevis pin 110 is the preferred coupling mechanism for hinge 100, however, other, similar coupling mechanisms, such as a nut and bolt, can he used.

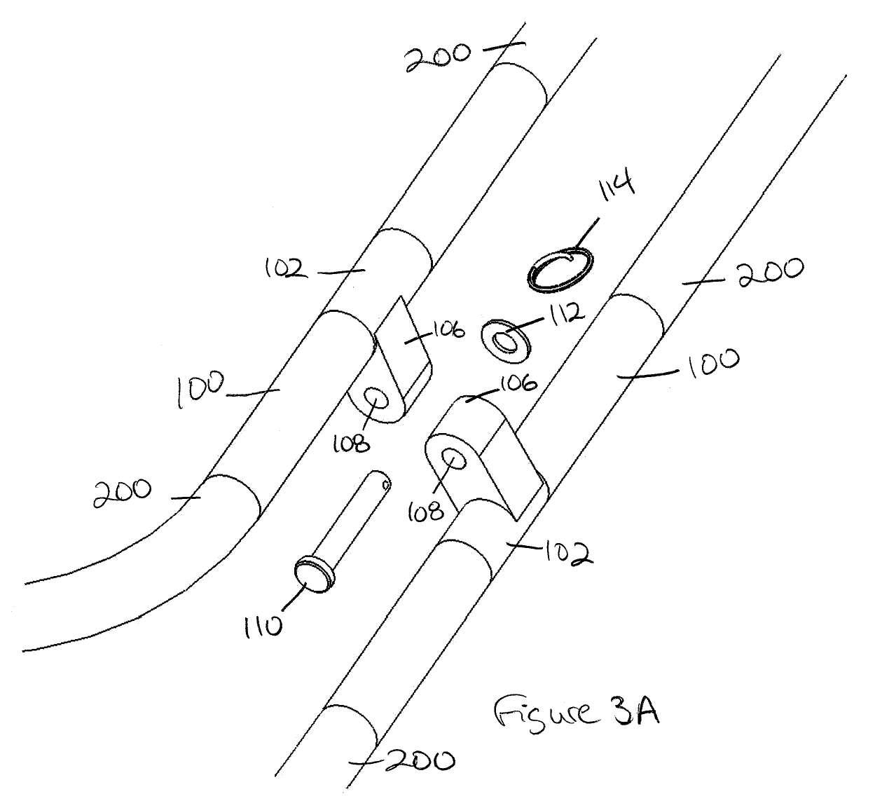

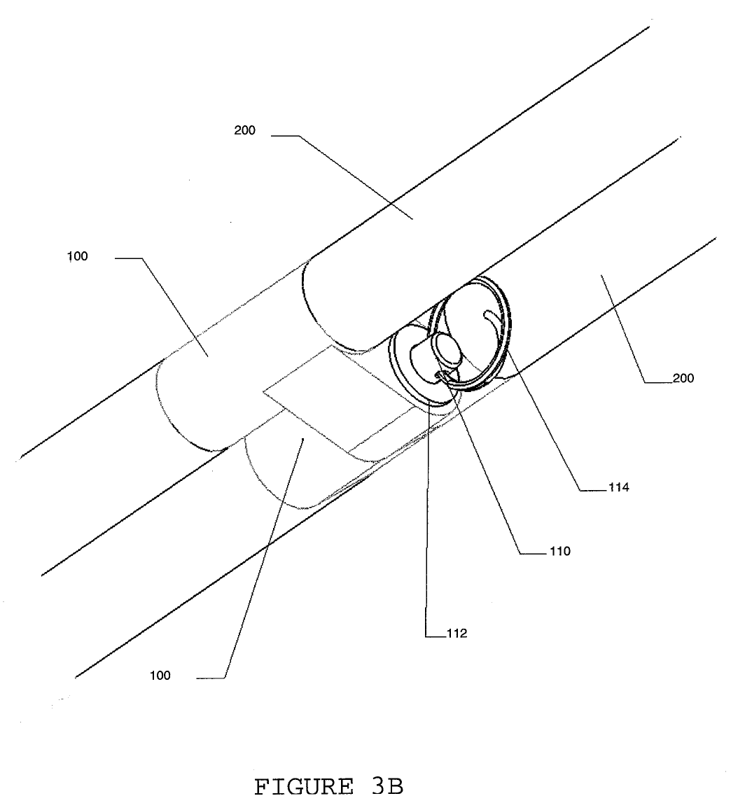

To couple two hinges 100, apertures 108 are aligned and clevis pin 110 is inserted into apertures 108 in adjacent locking mounts 106 as shown in FIGS. 3A and 3B. Cotter pin 114 then locks clevis pin 110 in place. If desired, a washer 112 can be used for additional security and stability. Advantageously, hinges 100 can be coupled together either before or after tubes 200 are secured to tube mounting ends 104.

The locking mount 106 is shown in an offset position on main body 102 such the two hinges 100 can be joined together in the same relative position with respect to the lifter 10. Alternate locking mounts, such as meshing loops secured through a central hole by a cotter pin, can also be used. Although an offset position allows for use of any hinge 100 in any position, and non-offset position which requires a fixed orientation of hinge 100 can be used in applications where this is desirable. In all cases, the dimensions of the locking mount 106 and any aperture 108 are determined by the materials used and expected stresses on the hinge 100.

The connected tubes 200 are used to form lifters 10 for use in between bows of a tarpaulin system. The lifter 10 pivots about hinge 100 via locking mount 106. The integration of the hinge 100 into the lifter reduces the weight and space required for the lifter. Also, as the hinge 100 is located substantially within the lifter 10, exposure to potential damages is also reduces.

The hinges and tubes can be made from plastic, aluminum, steel, or other materials as are known in the art. The hinges and tubes are preferably both made from the same material. Generally, the choice of materials will be determined by the requirements of the application for the tarpaulin system. Ideally, the hinge is fabricated such that the body 102, the tube mounting ends 104 and the locking mount 106 are formed as a single body.

As shown, the tubes 200, tube mounting ends 104 and aperture 108 are circular in cross-section, however, other cross-sections (e.g. oval, rectangular, hexagonal) can be used, and aperture 108 need not be similar in cross-section to tubes 200 and tube mounts 104. Additionally, the interior cross-section of tubes 200 can differ from the exterior cross-section.

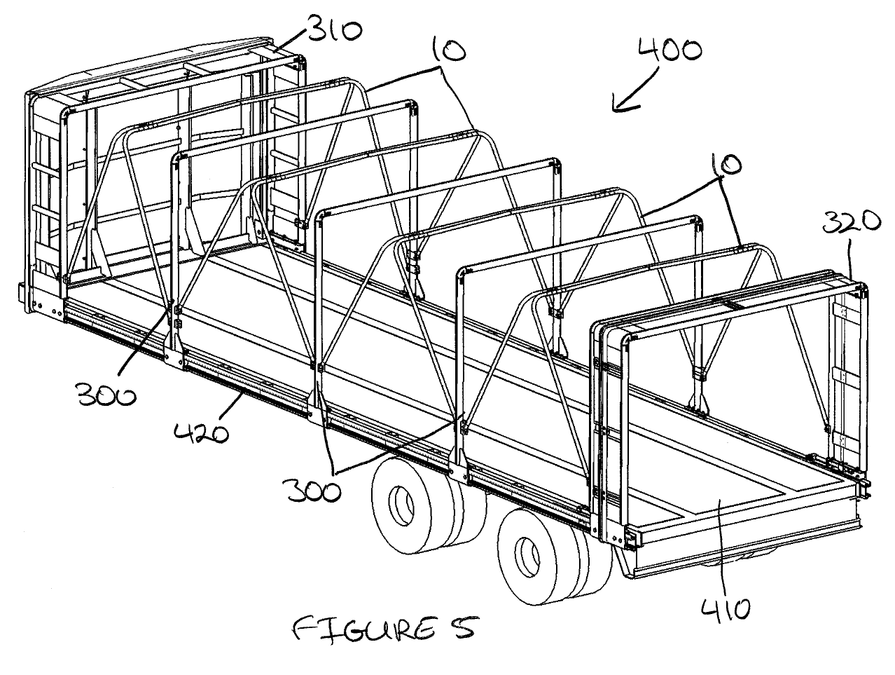

Operationally, as shown in FIGS. 4 and 5, the lifters 10 are attached between the bows 300 of the tarpaulin assembly 400, shown as a flatbed trailer. The bows 300 are mounted on a rail 420 or similar mounting device attached to the sides of the trailer deck 410, as is known in the art, to permit the bows 300 to be moved to one end of the trailer deck 410 for cargo loading, as seen in FIG. 4. Additional support is provided by front bow 310 and rear bow 320, which are reinforced to a greater degree than the bows 300. Once the cargo is loaded, the bows 300 are extended, as shown in FIG. 5, to allow the tarpaulin (not shown) to cover the cargo and to maintain the tarpaulin under tension. As shown, the bows are retracted towards the rear of the trailer deck 410, but can alternatively be retracted against the headboard 430, depending on the nature of the cargo being loaded and the design of the trailer.

As can be seen in FIGS. 4 and 5, the pivoting action of the lifters 10, enabled by the hinge 100, allows the lifters 10 to extend above the bows 300 when the bows 300 are moved together, keeping the tarpaulin from being trapped or damaged when folded up. When the bows 300 are extended, the lifters 10 descend to a position substantially level with the bows 300, thus maximizing cargo space while providing additional support to the tarpaulin.

While the above hinge has been presented in the context of tarpaulin systems the hinge is equally applicable to other applications requiring a disassemblable, pivoting hinge.

This concludes the description of a presently preferred embodiment of the invention. The foregoing description has been presented for the purpose of illustration and is not intended to be exhaustive or to limit the invention to the precise form disclosed. It is intended the scope of the invention be limited not by this description but by the claims that follow.

What is claimed is:

1. A modular lifter for a tarpaulin system, comprising:
a) a plurality of tubes, each end of each tube being a hollow end, and the tubes operative to be assemblable into a lifter for a tarpaulin system;
b) a plurality of hinges, each hinge having a body, opposed tube mounting ends extending longitudinally from the body and dimensioned to fit within the hollow ends of the tubes, and locking mount extending from the body substantially, perpendicular to the mounting ends; and
c) a locking mechanism, operative to couple two of said hinges together via respective locking mounts.

2. The modular lifter of claim 1, wherein the locking mechanism is a clevis pin and the locking mount contains an aperture for passage of the clevis pin.

3. The modular lifter of claim 2, wherein the locking mechanism is a clevis pin with a reusable cotter pin.

4. The modular lifter of claim 1, wherein the locking mechanism is a nut and bolt.

5. The modular lifter of claim 1, wherein each tube is substantially hollow.

6. The modular lifter of claim 5, wherein the tube mounting ends and the tubes are substantially circular in cross-section.

7. The modular lifter of claim 1, wherein the locking mount is in an offset position with respect to the body such that the coupled locking mount is overlapping the body of the coupled hinge.

8. The modular lifter of claim 1, wherein the body, the tube mounted ends and the locking mount of the hinge are a single body.

9. A hinge for a tarpaulin system, comprising:
a) a body,
b) a pair of tube mounting ends, each tube mounting end extending laterally from opposite ends of the main body, and
c) a locking mount extending perpendicular to the main body and enabling the hinge to be coupled to a second hinge of similar design.

10. The hinge of claim 9, wherein the locking mount contains an aperture to enable coupling of the second hinge via a clevis pin.

11. The hinge of claim 10, wherein the clevis pin uses a reusable cotter pin.

12. The hinge of claim 9, wherein the locking mount contains an aperture to enable coupling of the second hinge via a nut and bolt.

13. The hinge of claim 9, wherein the tube mounting ends are substantially circular in cross-section.

14. The hinge of claim 9, wherein the locking mount is in an offset position with respect to the body such that a coupled locking mount is overlapping the body of a coupled hinge.

15. The hinge of claim 9, wherein the body, the tube mounted ends and the locking mount are formed as a single body.
